(19) United States
(12) Patent Application Publication
(10) Pub. No.: US 2010/0060925 A1
(43) Pub. Date: Mar. 11, 2010

(54) Controlling Sensitive Information Leakage in Printing

(75) Inventor: Anil Francis Thomas, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/206,749

(22) Filed: Sep. 9, 2008

(51) Int. Cl. G06F 3/12

(52) U.S. Cl. 358/1.15

(57) ABSTRACT

Aspects of the subject matter described herein relate to controlling sensitive information leakage in printing. In aspects, one or more interception units sit in the print path(s) of a device. The interception unit(s) receives print data that is generated on the device and extract information from the print data. The extracted information is used to determine whether the print data include sensitive information. If the print data includes sensitive information, a policy is applied and the print data may or may not be forwarded towards a printer. Otherwise, the print data is forwarded towards a printer without applying a policy.

### BACKGROUND

Leaking sensitive information is a major concern for corporations. A company may have social security numbers, birth dates, addresses, credit card information, salary information, medical information or other sensitive information about various people. A company may also have company sensitive information that includes company trade secrets, mailing lists, marketing strategy, and other information that a company would like to keep secret. This information may be leaked in many ways including through e-mail, downloading to a portable storage device, printing, and so forth. Guarding against sensitive information leakage in printing is particularly challenging.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to controlling sensitive information leakage in printing. In aspects, one or more interception units sit in the print path(s) of a device. The interception unit(s) receives print data that is generated on the device and extract information from the print data. The extracted information is used to determine whether the print data include sensitive information. If the print data includes sensitive information, a policy is applied and the print data may or may not be forwarded towards a printer. Otherwise, the print data is forwarded towards a printer without applying a policy.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that represents some components of an exemplary system configured in accordance with aspects of the subject matter described herein;

FIG. 4 is a block diagram that represents some exemplary components of printing system that includes filters in according with aspects of the subject matter described herein;

FIG. 5 is a block diagram that represents some exemplary components of printing system that includes a print processor in according with aspects of the subject matter described herein; and

FIG. 6 is a flow diagram that generally represents actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. Other definitions, explicit and implicit, may be included below.

### Exemplary Operating Environment

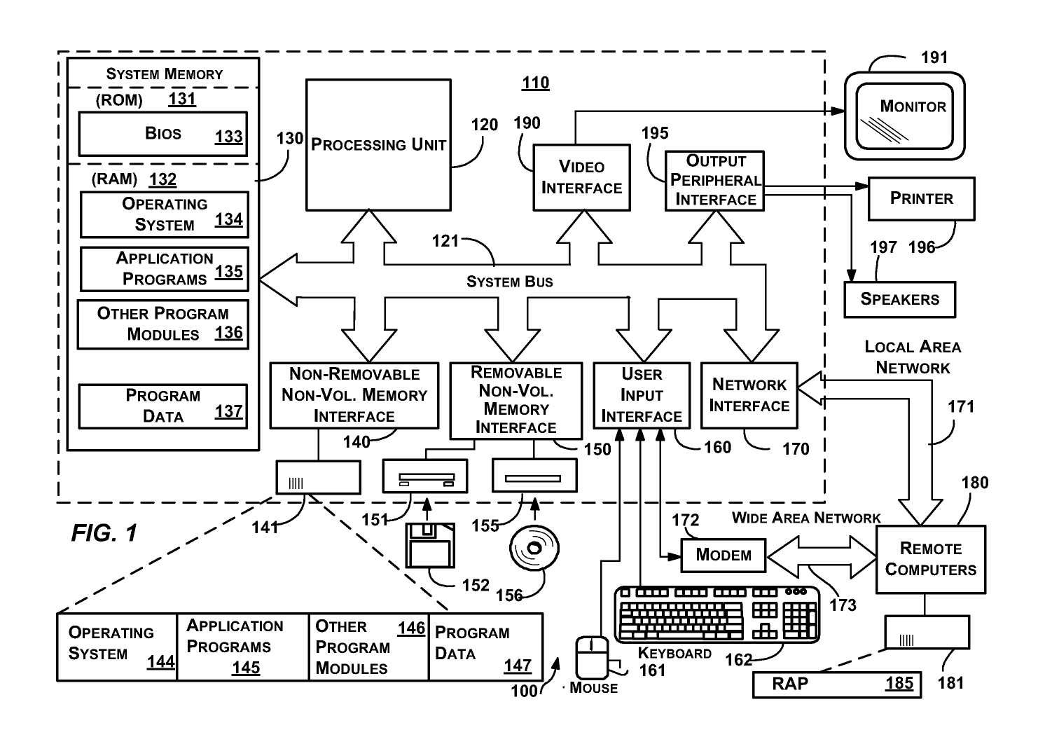

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Information Leakage in Printing

As mentioned previously, leaking sensitive information is a major concern. It is particularly challenging to control information leakage in printing. Some examples of possible sensitive information have been described previously, but there is no intention for these examples to be all-inclusive or exhaustive. Indeed, based on the teachings herein, those skilled in the art may recognize many other types of sensitive information that may be prevented or hindered from leaking by aspects of the subject matter described herein.

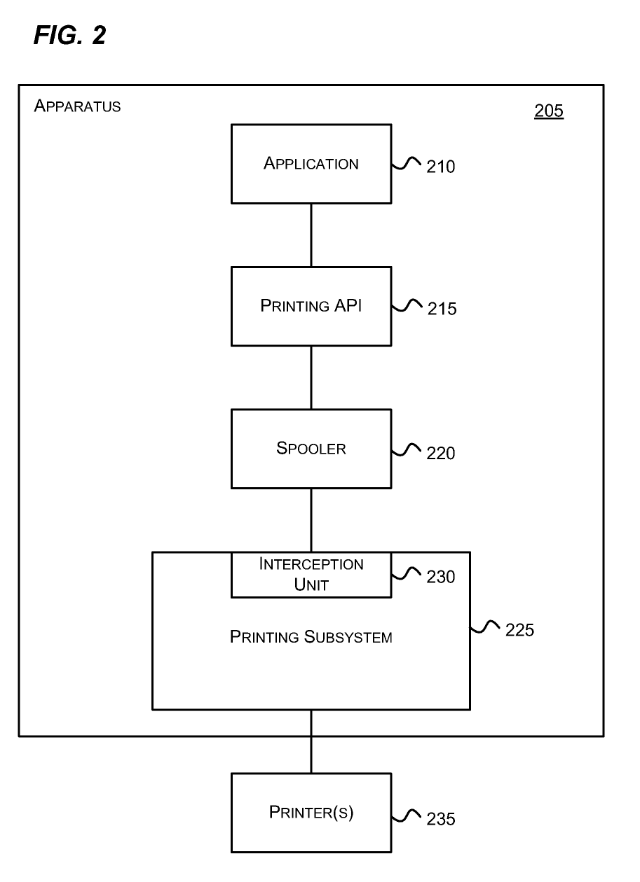

FIG. 2 is a block diagram representing an exemplary environment in which aspects of the subject matter described herein may be implemented. The environment may include an apparatus 205 and one or more printers 235. The apparatus 205 may be implemented on a computer (e.g., such as the computer 110 of FIG. 1). The apparatus 205 may include an application 210, a printing application programming interface (API), a spooler 220, a printing subsystem 225, and other components (not shown). The printing subsystem may include an interception unit 230 and other components (not shown).

The application 210 may include one or more processes that are capable of communicating with the printing API 215. The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. Likewise, the application 210 may have components that are distributed over one or more devices.

The printing API 215 comprises a programming interface that may be used by an application to print data. The printing API 215 may, for example, allow a process to submit print data, control print processes, and receive status about print jobs, printers, other printing information, and the like.

The spooler 220 provides a buffer in which data related to printing may be stored by the printing API 215 and accessed by the printing subsystem 225. This buffer may reside in volatile or non-volatile memory. The spooler 220 allows an application to quickly indicate information to be printed and then frees the application to do other tasks. The spooler 220 provides print information to the printing subsystem 225 at a rate the printing subsystem 225 needs the information. The spooler 220 may operate as a background task.

The printing subsystem 225 may include a print processor, a rendering engine, a print driver, or other components. Where needed, these components may assist in transforming print information provided by the print spooler into printer specific language that can be sent to a printer or back to the spooler 220. Sometimes, the print information buffered by the spooler 220 may be formatted in a format that is understood by one or more printers. In this case, the printing subsystem 225 may provide a communication path to the printer (e.g., by sending the information to a printer driver).

The interception unit 230 is a component that sits in the print path between the application 210 and the one or more printers 235. The interception unit 230 has an opportunity to examine data (sometimes called “print data”) sent between an application and a printer and is capable of extracting information from the data that may be used to determine whether the data contains sensitive information.

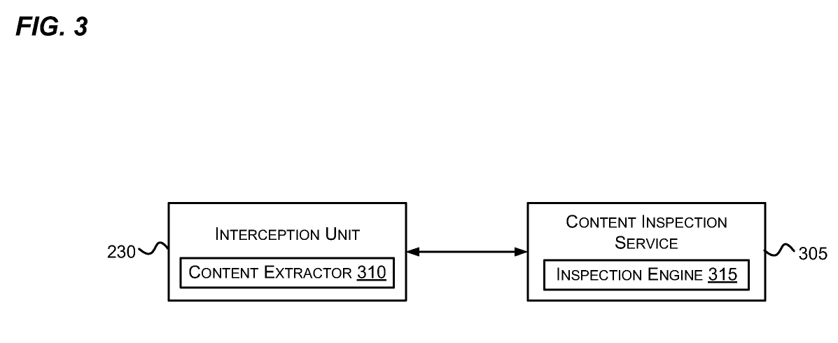

FIG. 3 is a block diagram that generally represents some components of an exemplary system configured in accordance with aspects of the subject matter described herein. The components include an interception unit 230 and a content inspection service 305. The inspection unit 230 includes a content extractor 310 while the content inspection service includes an inspection engine 315.

The content extractor 310 may extract information related to print jobs from the data received by the interception unit. Where the data has been transformed into an image or into commands that can be used to generate an image, the context extractor 310 may perform optical character recognition (OCR) on the image to obtain text from the image. Where the data is represented in a printing language, text corresponding to the original text of the document may be obtained from the data while printer commands may be discarded. Where the data includes meta-data or other content, the meta-data or other content may be extracted or may be discarded depending on the needs of the inspection engine 315.

The information extracted by the content extractor 310 may be sent to the content inspection service 305. With this information, the inspection engine 315 may determine whether the information includes sensitive information or not. Based on the teachings herein, those skilled in the art may recognize many techniques that may be used on the extracted information to determine whether the extracted information includes sensitive information or not. These techniques and others hereafter developed may be used without departing from the spirit or scope of aspects of the subject matter described herein.

If the content inspection service 305 determines that the data includes sensitive information, the content inspection service 305 may inform the interception unit 230. The interception unit 230 may then enforce a policy with respect to the data. Some exemplary policies include canceling the print job, presenting a user interface that asks the user to confirm that the user wishes to print the sensitive information, sending a message to a system administrator or the like that indicates that sensitive information has been printed, logging information that indicates a user that requested that the sensitive information be printed, take some other action, establishing an audit trail with respect to the requester who requested to print sensitive information, or the like.

If the content inspection service 305 determines that the content does not include sensitive information, the content inspection service 305 may so inform the interception unit 230. In response, the interception unit 230 may allow the print data to proceed towards a printer.

In one embodiment, the content inspection service 305 and the inspection engine 315 may be included in the interception unit 230 as subcomponents. In some embodiments, they may reside on a different device that the device upon which the interception unit 230 resides. In other embodiments, they may reside on the same device that the device upon which the interception unit 230 resides.

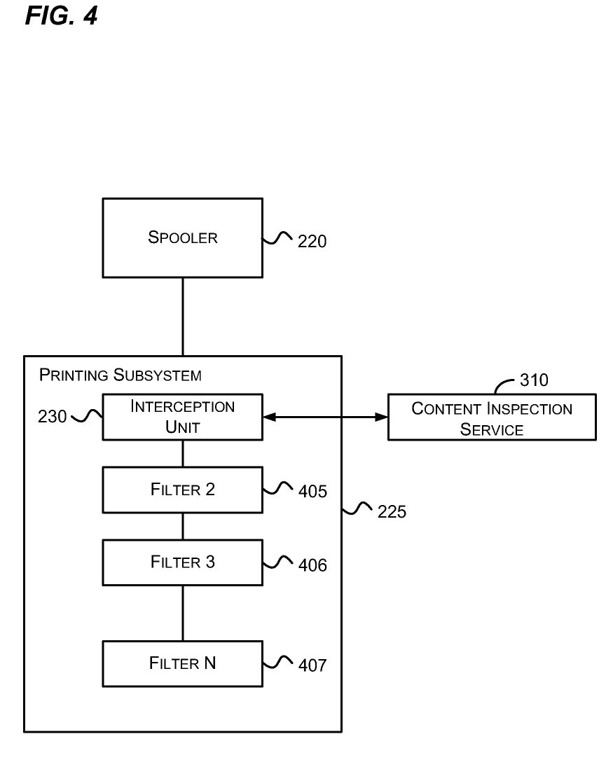

FIG. 4 is a block diagram that represents some exemplary components of printing system that includes filters in according with aspects of the subject matter described herein. As illustrated in FIG. 4, the printing subsystem 225 includes a filter stack that includes the interception unit 230 and filters 405-407. In this embodiment, the interception unit 230 may be implemented as a filter in the filter stack.

Filters are print processing components that may perform various operations on data that travels to or from a printer. For example, a filter may apply a watermark to a page. As another example, a filter may apply color management to a page. In the case of the interception unit 230, the interception unit 230 may extract data from the print jobs and provide this data to content inspection service 305. If the content inspection service 305 indicates that the data includes sensitive information, the interception unit 230 may take various actions to control leakage as has been described previously.

The interception unit 230 and the filters 405-407 may be ordered such that the interception unit 230 receives print data from the spooler 220 first and then sends the data if appropriate to the filter 405 which then sends the data to the filter 406, and so forth. Although the interception unit 230 is shown as first in the filter stack, in other embodiments, the interception unit 230 may be placed in other locations.

The print subsystem 225 may access a filter configuration file that describes how the filters of the printer driver are loaded, how they are called, and how data is passed between filters.

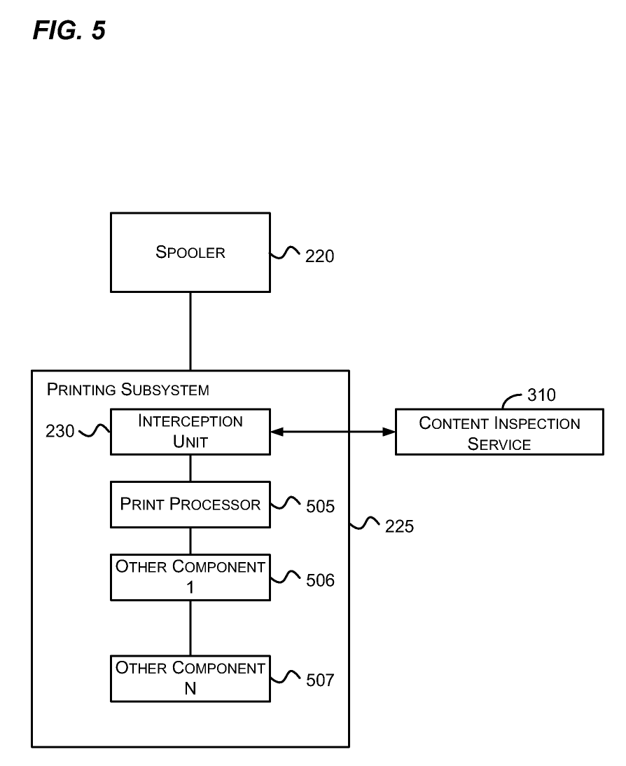

FIG. 5 is a block diagram that represents some exemplary components of printing system that includes a print processor in according with aspects of the subject matter described herein. As illustrated in FIG. 5, the printing subsystem 225 includes an interception unit 230, a print processor 505 and may also include zero or more other components 506-507.

A print processor (e.g., such as the print processor 505) may be responsible for converting data in a spooled format into a format that can be sent to a print monitor. A print monitor may direct the data to the appropriate port driver. A print processor may also have other responsibilities including handling application requests to pause, resume, and cancel print jobs.

As shown in FIG. 5, the interception unit 230 may act as a pseudo print processor. That is, the interception unit 230 may be placed between the spooler 220 and the print processor 505. The spooler 220 may be configured to call the interception unit 230 as a print processor instead of the print processor 550. The interception unit 230 may obtain data from the spooler 220 and may extract information to send to the content inspection service 305. If the content inspection service 305 indicates that the data includes sensitive information, the interception unit 230 may take various actions to control leakage as has been described previously.

If the content inspection service 305 indicates that the data does not include sensitive information, the interception unit 230 may pass the data unchanged to the print processor 505.

The other components 506-507, if any, may comprise a rendering engine, a print driver, or other components as needed or desired.

Returning to FIG. 2, although the interception unit 230 is shown in the printing subsystem 225, in other embodiments, the interception unit 230 may be placed in other locations. For example, the interception unit 230 may be placed between the application and the printing API 215. As another example, the interception unit 230 may be placed between the printing API and the spooler 220. As yet another example, the printing API may be placed within the spooler 220. Indeed, the interception unit 230 may be placed in virtually any location at which the interception unit 230 will be able to receive data directed to a printer.

As other examples, in one embodiment, the interception unit 230 may be placed such that it replaces or supplements the printing API. In another embodiment, the interception unit 230 may be implemented as a partial print provider. In yet another embodiment, the interception unit 230 may be implemented as a queue manager with two queues. Applications can print to one queue which the interception unit 230 extracts data from. If a print job is deemed non-sensitive, it may be moved to another print queue that a printer prints from. In yet another embodiment, the interception unit 230 may be placed in a networking stack to monitor for print jobs that are sent via a network.

In a given implementation, there may more than one instance of the interception unit 230. For example, the interception unit 230 may be placed before the spooler 220 and in the printing subsystem 225. As another example, there may be more than one interception unit 230 in the printing subsystem 225 to take care of multiple print paths.

Various of the components above may have responsibilities that include determining whether a print job is to be handled locally or across a network, determining a physical printer that will be used to print a print job, converting a data stream from a spooled format to a format that can be used by a printer, sending a data stream of a print job to a printer, and so forth.

Furthermore, in one embodiment, one or more of the components above may execute in user mode, in kernel mode, some other mode, a combination of the above, or the like.

Although the environment described above includes various components related to printing, it will be recognized that more, fewer, or a different components may be employed without departing from the spirit or scope of aspects of the subject matter described herein. Furthermore, the components included in the environment may be configured in a variety of ways as will be understood by those skilled in the art without departing from the spirit or scope of aspects of the subject matter described herein.

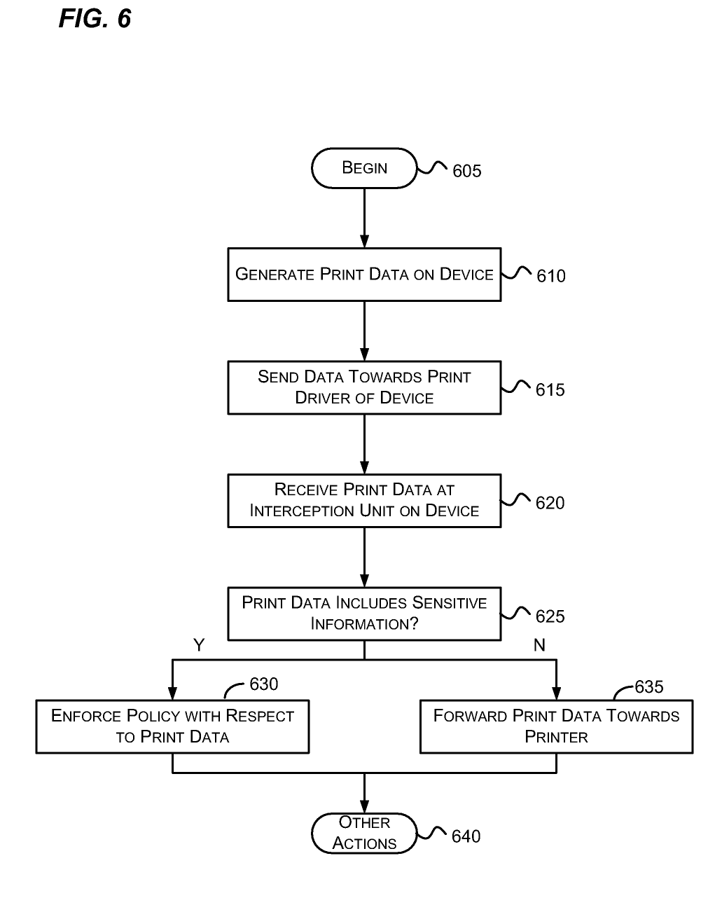

FIG. 6 is a flow diagram that generally represents actions that may occur in accordance with aspects of the subject matter described herein. For simplicity of explanation, the methodology described in conjunction with FIG. 6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 6, at block 605, the actions begin. At block 610, print data is generated on a device. For example, referring to FIG. 2, the application 210 generates print data by calling the printing API 215 and submitting data to be printed.

At block 615, the data is sent towards a print driver of the device. For example, referring to FIG. 2, the print data generated by the application 210 is forwarded towards a print driver in the printing subsystem 225. In route to the print driver, the print data may pass through the spooler 220, the interception unit 230, and various other components and may be modified as it passes through these components.

At block 620, the print data is received at an interception unit on the device. For example, referring to FIG. 2, the interception unit 230 eventually receives the print data.

At block 625, a determination is made as to whether the print data includes sensitive information. If so, the actions continue at block 630; otherwise, the actions continue at block 635. For example, referring to FIG. 3, the content extractor 310 of the interception unit 230 extracts information from the print data. This information is then sent to the content inspection service 305 which uses the inspection engine 315 to determine whether the information includes sensitive information. The content inspection service 305 then informs the interception unit data is 410 whether the print data includes sensitive information.

At block 630, a policy is enforced with respect to the print data. For example, referring to FIG. 205, the interception unit may cancel the print job or take other actions as described previously.

At block 635, the print data is forwarded towards the printer. For example, referring to FIG. 2, the interception unit 230 may forward the data towards one of the printers 235 via other components within the printing subsystem 225.

At block 640, other actions, if any, may occur.

As can be seen from the foregoing detailed description, aspects have been described related to controlling sensitive information leakage in printing. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
generating print data on a device;
sending the print data towards a print driver of the device;
on the device, receiving the print data at an interception unit that has an opportunity to examine data sent towards a printer associated with the print driver;
determining whether the print data includes sensitive information; and
if the print data includes sensitive information, enforcing a policy with respect to the print data.

2. The method of claim 1, further comprising if the print data does not include sensitive data, forwarding the print data towards a printer on which the print data is to be printed.

3. The method of claim 1, wherein the printer is attached to the device without an intermediate print server between the device and the printer.

4. The method of claim 1, wherein the printer is attached to a print server between the device and the printer.

5. The method of claim 1, further comprising if the print data does not include sensitive data, storing data in a file, the data corresponding to the print data and formatted according to a printer specific language.

6. The method of claim 1, wherein receiving the print data in an interception unit comprises receiving the print data at the interception unit before the print data is transformed into a printer specific language.

7. The method of claim 1, wherein receiving the print data in an interception unit comprises receiving the print data at the interception unit after the print data is transformed into a printer specific language.

8. The method of claim 1, wherein receiving the print data at an interception unit comprises receiving the print data at a filter of a filter stack.

9. The method of claim 1, wherein receiving the print data at an interception unit comprises receiving the print data at a pseudo print processor that calls another print processor to perform printer-related operations.

10. The method of claim 1, wherein determining whether the print data includes sensitive information comprises performing optical character recognition on an image represented by the print data.

11. The method of claim 1, wherein determining whether the print data includes sensitive information comprises extracting content from the print data and sending the content to a content inspection service.

12. In a computing environment, an apparatus, comprising:
an application operable to perform operations to request that data be printed;
a spooler operable to buffer print data corresponding to the data;
an interception unit operable to receive the print data and to extract information from the print data; and
a content inspector operable to examine the information to determine whether the information includes sensitive information.

13. The apparatus of claim 12, wherein the interception unit comprises a filter in a print path between the application and a printer upon which the data is to be printed.

14. The apparatus of claim 12, wherein the interception unit comprises a pseudo print processor in a print path between the application and a printer upon which the data is to be printed, the pseudo print processor operable to call another print processor to perform printer-related operations.

15. The apparatus of claim 12, wherein the interception unit is located between the application and a driver that transforms the print data into a printer specific language.

16. The apparatus of claim 12, wherein the interception unit is located after a driver that transforms the print data into a printer specific language.

17. The apparatus of claim 12, wherein the interception unit comprises a component in a print path between the application and a file subsystem upon which a document corresponding to the data is to be stored in a printer specific language.

18. A computer storage medium having computer-executable instructions, which when executed perform actions, comprising:
on a device, before a print driver receives data corresponding to a print job, receiving print data generated on the device, the print data directed towards a print driver, the print driver responsible for generating printer specific data corresponding to the print data;
determining whether the print data includes sensitive information; and
if the print data includes sensitive information, enforcing a policy with respect to the print data.

19. The computer storage medium of claim 18, wherein enforcing a policy with respect to the print data comprises refraining from printing the print job.

20. The computer storage medium of claim 18, wherein enforcing a policy with respect to the print data comprises establishing an audit trail with respect to a requester who requested to print the sensitive information.
